(19) United States
(12) Patent Application Publication
(10) Pub. No.: US 2020/0291625 A1
(43) Pub. Date: Sep. 17, 2020

(54) WALL-FAUCET DEVICE FOR FREEZE PREVENTION IN PIPE-LINE SYSTEMS

(71) Applicant: Javier Vila, Kennesaw, GA (US)

(72) Inventor: JAVIER VILA, KENNESAW, GA (US)

(21) Appl. No.: 16/818,979

(22) Filed: Mar. 13, 2020

Related U.S. Application Data
(60) Provisional application No. 62/818,714, filed on Mar. 14, 2019.

(51) Int. Cl. E03B 7/12; G05D 23/08

(52) U.S. Cl. CPC E03B 7/12; G05D 23/08

(57) ABSTRACT

A nonpowered wall-faucet device is used for freeze prevention in water pipeline systems. The wall-faucet device is easy to build and install on exterior water spigots. The device contains a ball valve system, a float valve system, and a temperature sensitive valve system.

### CROSS-REFERENCE TO RELATED APPLICATIONS

This application claims the benefit of U.S. Provisional Application No. 62/818,714 filed on Mar. 14, 2019, which is hereby incorporated in its entirety.

### FIELD OF THE INVENTION

The present invention is directed to a wall-faucet device for freeze prevention in pipe-line systems. More specifically, the invention relates to a temperature-controlled wall-faucet device that does not require a power source.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

During the winter months, a common problem in water supply systems is that the water can freeze when the outside temperature drops below a certain threshold. Water in pipe-line systems begins to expand and subsequently begins to freeze between 39.2° F. and 32° F. Therefore, various devices and methods have been envisioned to prevent this problem and mitigate its consequences.

Some of the devices currently available rely on electronic circuits, pumps, sensors and electronic valves, making them relatively expensive to manufacture and maintain. In addition, they are sensitive to extreme temperatures and exposure to other weather elements. Reliance on a power supply to prevent freezing in a water pipe-line system is only beneficial if power remains on during the entire winter season. Individuals tend to minimize power usage in their home when they are away for long periods of time, making this option unavailable. Likewise, individuals who tend to lose power during heavy winter storms will not be able to protect their water pipes from freezing when the electricity is nonfunctional.

Existing devices for freeze protection by insulation are expensive and have a local effect, meaning they only protect those pipes which are insulated. Other devices use compressible elements for freeze protection. However, these devices are difficult to design and install, they typically only operate at the design pressure, and they only have a local effect. Finally, current systems that use drainage have a local effect and are unusable while the system is operational.

Currently, existing devices for freeze protection that use a pressure-sensitive valve to release water have four main disadvantages: (1) they have to be carefully designed; (2) they cannot withstand standard manufacture tolerances; (3) they typically do not work outside of the design pressure; and (4) they may only have a local effect. The main problem with the current systems is they are built to function under nominal pressure but open the drainage valve as the temperature increases. In addition, they are sensitive to external pressure. For example, ice formation at a point upstream in the system may not trigger the valve to continuously release water, decreasing the effectiveness of the device.

Therefore, there exists a need for a non-powered temperature-sensitive device that releases water when the atmospheric temperature drops below a set value.

### SUMMARY OF THE INVENTION

An object of this invention is to provide a simple mechanical apparatus that is sensitive to the atmospheric temperature surrounding the device and provides protection against freezing problems in pipe-line systems for fluid conduction, which is applicable but not restricted to water supply systems. The wall-faucet device has a valve that opens when the exterior temperature drops below a certain pre-selected value. The pre-selected value is chosen at the design phase by the length and torsional stiffness of the bimetallic coil. The wall-faucet device does not require a power supply, making it simple and suitable to operate unattended for long periods of time. The device protects and prevents freezing everywhere upstream in the pipes leading to the installation point, further preventing the bursting of the main water supply pipe.

A wall-faucet device for freeze prevention in water pipe-line systems comprises a chamber, a main pipe, a ball valve system, a float valve system, and a temperature sensitive valve system. The chamber comprises a discharge tube, a water release orifice, an interior top surface, an interior back surface, an interior bottom surface, an interior front surface, an interior first side surface, and an interior second side surface. The main pipe comprises a water intake orifice between the main pipe and the chamber.

The ball valve system comprises a valve O-ring, a spherical valve, a lever, a faucet O-ring, and a port. The valve O-ring is mounted on the spherical valve, wherein the lever is attached through the valve O-ring to the spherical valve by a fastener. The faucet O-ring is located at the joint of the spherical valve and the port.

The float valve system is located in the chamber and comprises a hollow float, a cylindrical threaded rod, a horizontal cylindrical shell, a plurality of triangular plates, a rectangular tab, a hexagonal cavity, a horizontal cylinder, a first cylindrical piston, and a plurality of protrusions. The hollow float is affixed to the horizontal cylindrical shell by a plurality of triangular plates. A horizontal cylinder is inserted through the horizontal cylindrical shell fixedly attaching the horizontal cylindrical shell between the interior first side surface and the interior second side surface of the chamber.

A rectangular tab is permanently attached to the hollow cylindrical shell of the hollow float. A cylindrical threaded rod is screwed into the rectangular tab by a hexagonal wrench inserted into hexagonal cavity. The first cylindrical piston is positioned between the cylindrical threaded rod and the plurality of protrusions. The plurality of protrusions are located on the interior top surface of the chamber, wherein the plurality of protrusions are configured to hold the first cylindrical piston in place.

The temperature sensitive valve system comprises a second cylindrical piston, a bimetallic coil, a lid, a plurality of horizontal rails, a cantilever section, a transverse groove, a casing, an air intake orifice, a housing box, a tab, an indentation, and a cylinder. The temperature sensitive valve system is confined to a housing box wherein the lid comprises a plurality of apertures used for aerial communication between the temperature sensitive valve system and the exterior of the device. The lid is removably attached to the housing box and comprises an indentation configured to hold the tab securely in place. The bimetallic coil is clamped to the cylinder by a transverse groove and wrapped around said cylinder housed in the casing.

The freeze prevention device comprises polyvinyl chloride (PVC) or galvanized steel. The freeze prevention device further comprises a one-way valve attached to the male threaded outlet.

A method for preventing freezing in water pipeline systems comprises the following steps: a) operating at a temperature above 36° F.; b) operating at a water pressure of 40 PSI; c) water entering the device through the main pipe; d) controlling the water flow by the ball valve system; e) communicating with the exterior by air intake orifice and the water release orifice located in the chamber; f) closing the water intake orifice by the hollow float when the water reaches the threshold level of 80 mm within the chamber, by sealing the first cylindrical piston against the water intake orifice; g) winding of the bimetallic coil around the cylinder, holding second cylindrical piston against the air intake orifice, preventing exterior air from being introduced into the chamber; h) water exiting the device through the male threaded outlet; and i) water stopping once the water pressure in the chamber is below the exterior atmospheric pressure.

In addition, the wall-faucet device comprises a chamber where the water pressure remains constant and atmospheric within the chamber (measured at the discharge tube), and equal to the atmospheric pressure outside the chamber, allowing for a simpler and more robust design of the temperature-sensitive valve system. The temperature sensitive valve system is isolated in its operability from pressure changes in the pipe-line system, making it invulnerable to such pressure changes.

The present invention is easy to install on pre-existing pipe-line systems and in newly constructed homes. The wall-faucet device can also be installed as an outdoor spigot. The design is simple and easy to fabricate by standard procedures; such as casting, hot forging, injection molding, and computer numerical control (CNC) machining.

These and other objects are realized, and the limitations of the prior art are overcome in this invention by providing a chamber that is connected to the pressurized water pipe-line system. The chamber is independent from the pressure inside the pipe-line system. In addition, the water level in the chamber is maintained at a certain level by a float valve system.

The float valve system senses when the water decreases below a set threshold and enables the valve to open, increasing the intake of water. Once the water level returns to its set threshold limit, the valve closes ceasing the flow of water. The water release flow rate can be set to any desired value and is not affected by pressure changes in the water pipe-line system. The water release flow rate is from about 0 to 0.25 liters per second. In another embodiment, the water release flow rate is from about 2.10⁻⁷ to 2.10⁻⁵ liters per second. The water release flow rate depends on the diameter and length of the discharge tube and the set threshold water level within the chamber. Increasing the diameter of the discharge tube and/or the threshold water level increases the water flow rate. Decreasing the length of the discharge tube increases the water flow rate. Thus, the water flow rate can be adjusted by changing the diameter and/or length of the discharge tube and the threshold water level. In addition, the water pressure in the chamber is close to atmospheric, such that the valve that triggers or prevents the water release requires relatively low mechanical force.

The water release orifice, located at the bottom of the chamber, allows water to be discharged from the chamber by the discharge tube. The length and diameter of the discharge tube is designed to allow for a small flow or trickle of water when the air intake orifice is open. The flow of the water to the outside the chamber decreases the water level in the chamber, forcing the float valve system away from the top surface of the chamber, enabling water to fill the chamber from the main pipe. Once the chamber reaches the set threshold water level, the float valve system moves toward the top surface of the chamber, closing the water intake orifice.

The air intake orifice is located on the interior back surface of the chamber and is operated by a bimetallic coil. When the air intake orifice is in the closed position, the pressure in the chamber decreases as the water flows out. The water flow stops when the outside atmospheric pressure is equivalent to the inside water pressure (minus surface tension). A thermally sensitive bimetallic coil winds and unwinds, depending on the outside temperature, allowing the air intake orifice to open and close through motive power. Due to the coil's bimetallic properties, the coil winds or unwinds depending on the change in temperature. The bimetallic coil provides a displacement and/or a force at the tip thereof, proportional to the temperature change, due to the difference in dilation coefficients of its two components, thus amplifying the effect of deformation by temperature.

Therefore, the float valve lessens the pressure of water, and the bimetallic coil amplifies the temperature-dilation differential deformation; mechanisms whereby a simple and robust autonomous trickle device for freeze prevention is possible.

In addition, the device comprises a main pipe and a ball valve system, to supply water downstream as a regular faucet. The operation of the ball valve system is independent of the temperature-sensitive valve system.

Various objects, features, aspects and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is a right-side view of an exemplary embodiment of a wall-faucet device.

FIG. 2a is a back-right-top isometric perspective view of an exemplary embodiment of a wall-faucet device.

FIG. 2b is a front-right-bottom isometric perspective view of an exemplary embodiment of a wall-faucet device.

FIG. 3a is a section view from the right of an exemplary embodiment of a wall-faucet device showing the float valve system.

FIG. 3b is a section view from the front of an exemplary embodiment of a wall-faucet device showing the float valve system.

FIG. 4 is an exploded perspective view of an exemplary embodiment of a wall-faucet device showing the float valve system and ball valve system.

FIG. 5a is a front surface exterior section view of an exemplary embodiment of the wall-faucet device.

FIG. 5b is an exemplary embodiment of the lid of wall-faucet device.

FIG. 5c is a perspective view of an exemplary embodiment of the lid of a wall-faucet device.

FIG. 6a is an exemplary embodiment of a temperature sensitive valve system.

FIG. 6b is an interior view of a housing box for the temperature sensitive valve system.

FIG. 7 is an operational view of a wall-faucet device operating at a high temperature.

FIG. 8 is an operational view of a wall-faucet device operating at a low temperature.

FIG. 9 is an operational view of a wall-faucet device where the ball valve system is open, operating independent of the temperature (low temperature in the figure).

FIG. 10 is an alternate embodiment of a wall-faucet device where the temperature sensitive valve system is located at the bottom of device.

FIG. 11 is a perspective view of a vertical-transverse section of the alternate embodiment of a wall-faucet device where the temperature sensitive valve system is located at the bottom of device.

FIG. 12a is a detailed view of the float valve from the section of the alternate embodiment of a wall-faucet device where the temperature sensitive valve system is located at the bottom of device.

FIG. 12b is a detailed view of the temperature-sensitive valve from the section of the alternate embodiment of a wall-faucet device where the temperature sensitive valve system is located at the bottom of device.

### DETAILED DESCRIPTION

The present invention is directed to a wall-faucet device used for freeze prevention in water pipe-line systems.

As used in the description herein and throughout the claims that follow, the meaning of “a” “an”, “and”, and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute of the numeral to 10% above the absolute of the numeral, inclusive.

As used in the description herein and throughout the claims that follow, the meaning of “hexagonal cavity” is synonymous with “grub screw” or “set screw.”

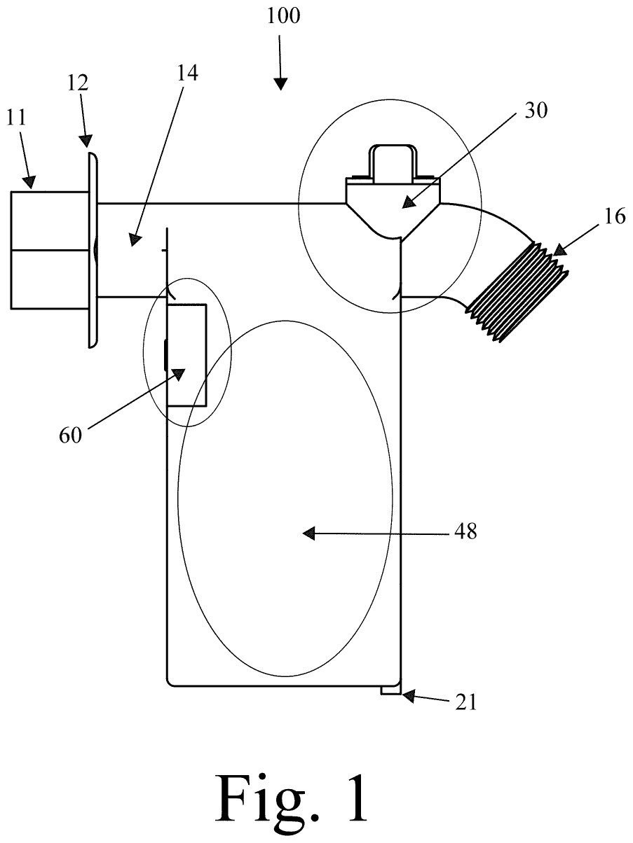

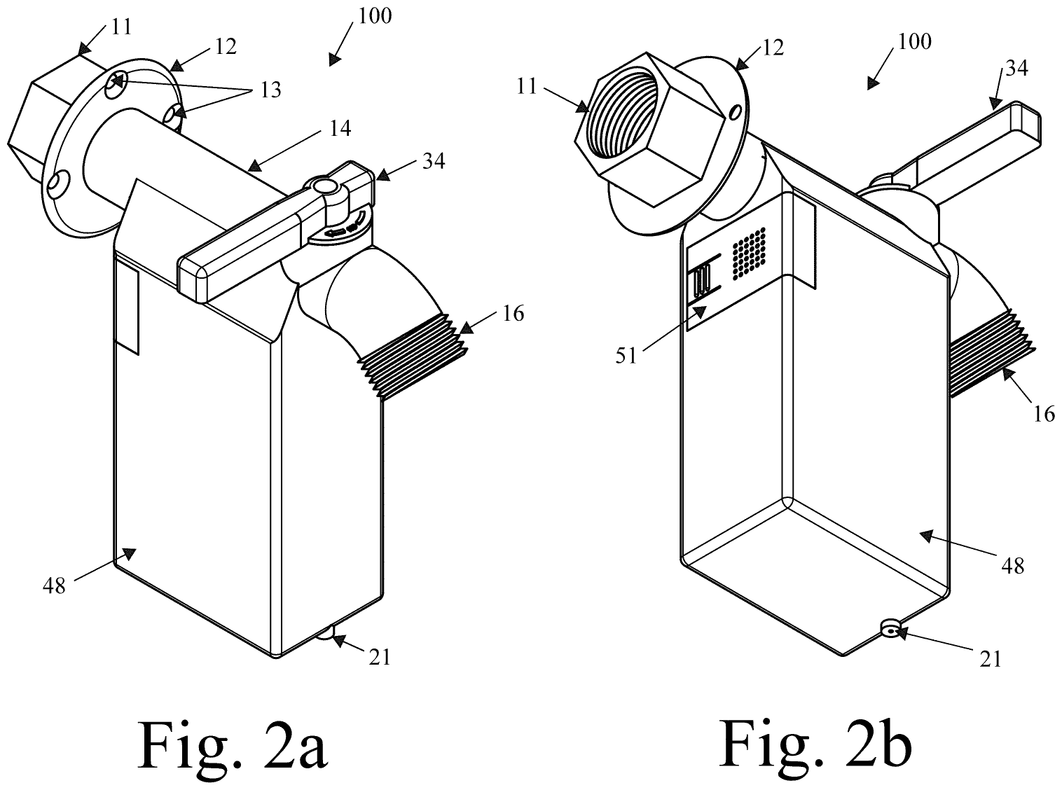

An exemplary configuration of the present invention is depicted in FIGS. 1-6b, in which wall-faucet device 100 is configured to attach to the exterior faucet of a building. In one embodiment, wall-faucet device 100 comprises main pipe 14, ball valve system 30, float valve system 40, temperature sensitive valve system 50, discharge tube 20, female threaded connector 11, disk 12, and male threaded outlet 16 (see FIG. 1).

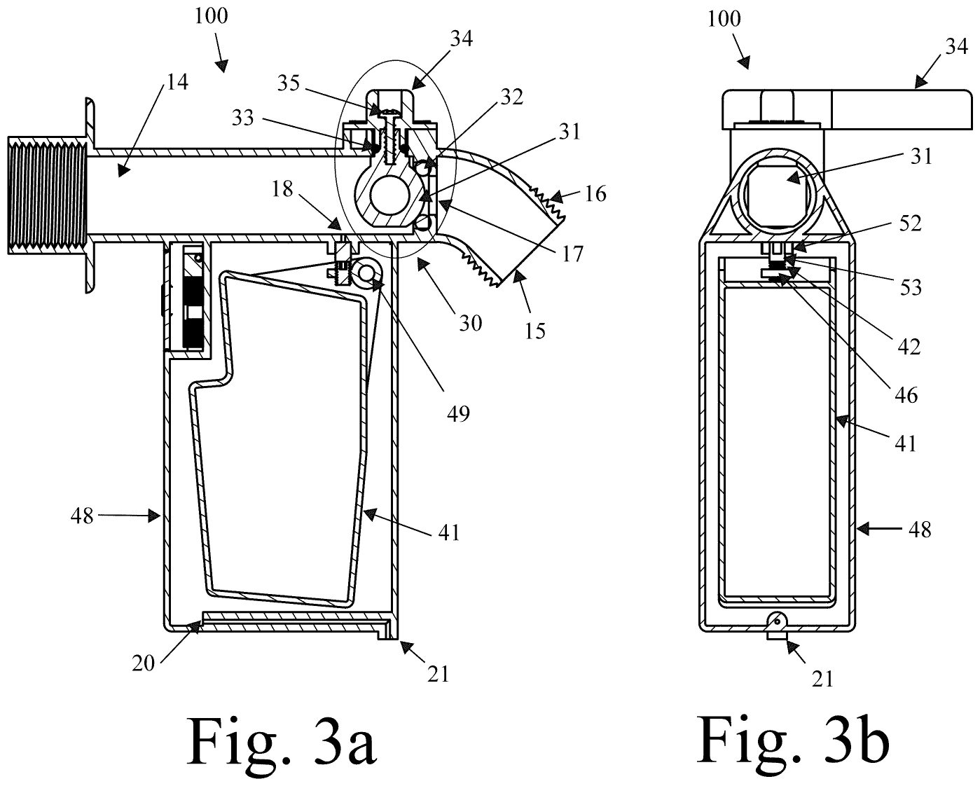

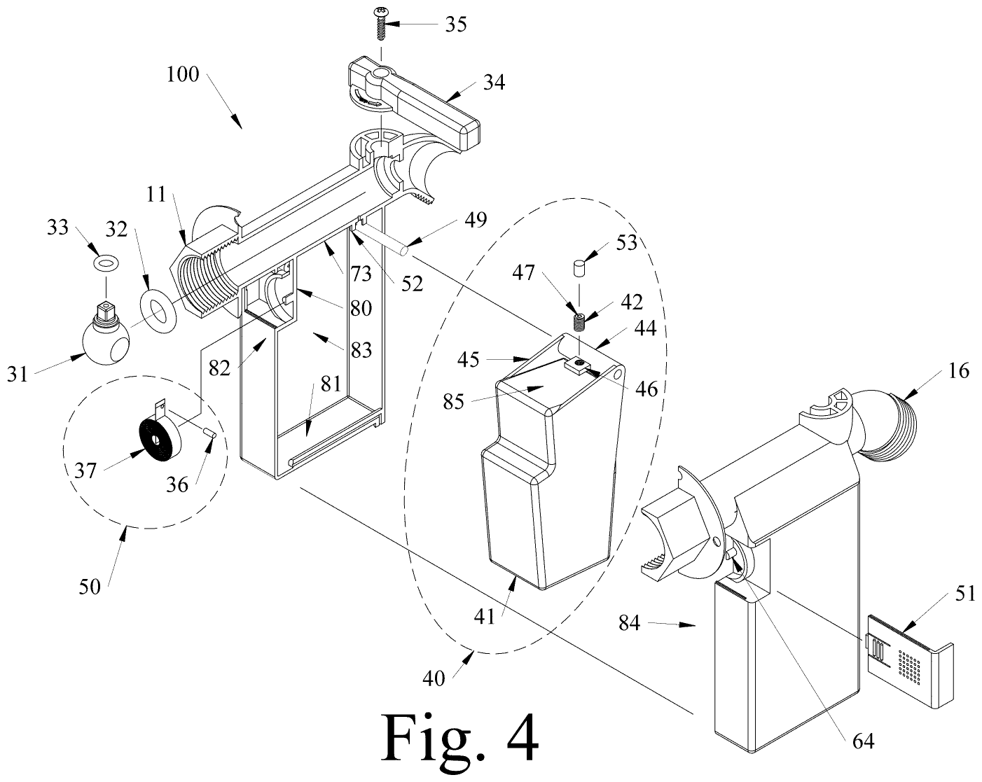

Ball valve system 30 comprises spherical valve 31, faucet O-ring 32, valve O-ring 33, lever 34, and screw 35 (see FIGS. 3a-4). Faucet O-ring 32 seals the joint of spherical valve 31 against flat ring-shaped port 17 located at the juncture of main pipe 14 and male threaded outlet 16. Lever 34 is attached to spherical ball 31 with screw 35. Valve O-ring 33 is attached to spherical valve 31 to prevent water leakage at joints.

In one embodiment, float valve system 40 comprises hollow float 41, cylindrical threaded rod 42, first cylindrical piston 53, horizontal cylindrical shell 44, plurality of triangular plates 45, rectangular tab 46 and chamber 48 (see FIGS. 3a-4). Float valve system 40 regulates the flow of water from main pipe 14 through water intake orifice 18 and into chamber 48, ensuring a constant level of water is maintained within chamber 48.

Hollow float 41 is shaped so it is able to freely rotate 10 degrees around horizontal cylinder 49 without any of its faces being closer than 2 mm to touching any interior surface of chamber 48. Plurality of triangular plates 45 are permanently affixed between hollow float 41 and horizontal cylindrical shell 44 wherein horizontal cylinder 49 is inserted through horizontal cylindrical shell 44 fixedly attaching horizontal cylindrical shell 44 between interior first side surface 83 and interior second side surface 84 of chamber 48, thus serving as a hinge mechanism.

Rectangular tab 46 is permanently attached to horizontal cylindrical shell 44 wherein cylindrical threaded rod 42 screws into rectangular tab 46 by means of hexagonal cavity 47 which readily accepts a hexagonal wrench. First cylindrical piston 53 is positioned between cylindrical threaded rod 42 and plurality of protrusions 52 wherein plurality of protrusions 52 hold first cylindrical piston 53 in place. In this position, first cylindrical piston 53 can move up and down within chamber 48 to open and close water intake orifice 18, but first cylindrical piston 53 is unable to move from side to side. Air intake orifice 59 is located on interior back surface 80 of chamber 48 and is operated by bimetallic coil 37.

Plurality of protrusions 52 are affixed to interior top surface 73 of chamber 48. When the wall-faucet device 100 is connected to the water pipe-line system, water enters main pipe 14 and flows into chamber 48 through water intake orifice 18. As hollow float 41 rises in chamber 48, hollow float 41 rotates around horizontal cylinder 49, moving rectangular tab 46 and cylindrical threaded rod 42 upwards and compressing first cylindrical piston 53 against water intake orifice 18, thus sealing water intake orifice 18 once the water reaches the set threshold level. When the temperature decreases, air intake orifice 59 opens, allowing air to flow inside chamber 48. Thus, when air intake orifice 59 is open, water flows out of chamber 48 through discharge tube 20, exiting through water release orifice 21 at a small flow rate between about 2.10⁻⁷ to about 2.10⁻⁵ liters per second. Alternatively, when air intake orifice 59 is closed, the flow of water from chamber 48 through discharge tube 20 and water release orifice 21 ceases.

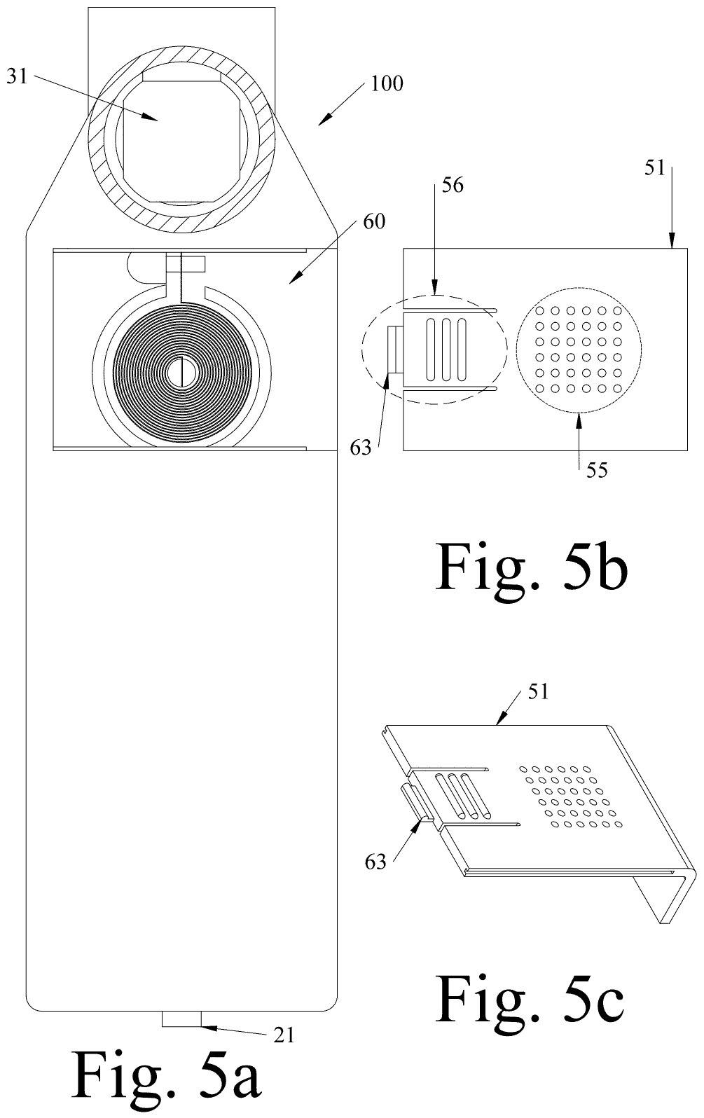

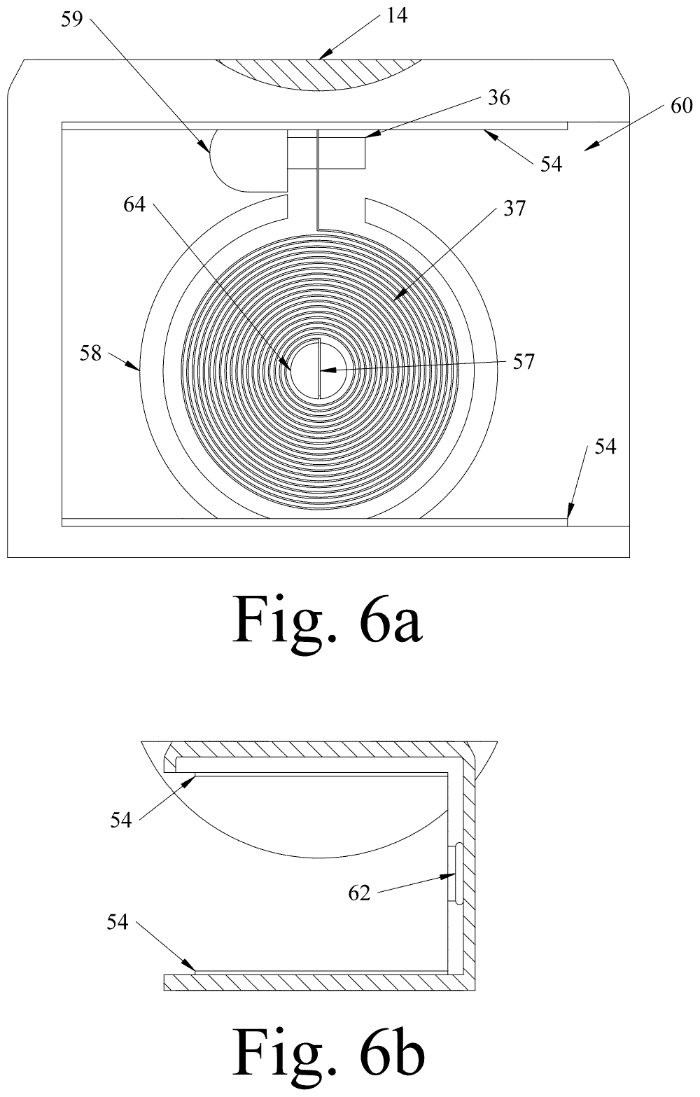

In one embodiment, temperature sensitive valve system 50 comprises lid 51, bimetallic coil 37, second cylindrical piston 36, plurality of horizontal rails 54, plurality of apertures 55, cantilever section 56, transverse groove 57, casing 58, and air intake orifice 59 (see FIGS. 5a-6b). Temperature sensitive valve system 50 is located in housing box 60 (see FIGS. 1, 5a and 6a) located on exterior front surface 82 of chamber 48 below female threaded connector 11. In an embodiment, lid 51 is removably attached to housing box 60 by plurality of horizontal rails 54 allowing a user to access temperature sensitive valve system 50 by sliding lid 51 along plurality of horizontal rails 54 away from wall-faucet device 100 (see FIGS. 5a-5c).

In an exemplary embodiment, lid 51 comprises a plurality of apertures 55 to ensure aerial communication between temperature sensitive valve system 50 and the exterior. Cantilever section 56 is a flexible locking mechanism wherein indentation 63 is configured to hold tab 62 securely in place to prevent housing box 60 from opening unintentionally. In one embodiment, lid 51 is removably attached to housing box 60 by plurality of horizontal rails 54, wherein lid 51 slides along plurality of horizontal rails 54 to open and close housing box 60.

In an embodiment, bimetallic coil 37 is clamped to cylinder 64 by inserting one end of bimetallic coil 37 into transverse groove 57 (see FIG. 6a). As the ambient temperature decreases bimetallic coil 37 is wrapped around cylinder 64 and inserted into casing 58. Bimetallic coil 37 unwinds, rotating clockwise, inside casing 58, separating second cylindrical piston 36 from air intake orifice 59, thus allowing exterior air into chamber 48. Alternatively, as the ambient temperature increase, bimetallic coil 37 winds, rotating counterclockwise, around cylinder 64, compressing second cylindrical piston 36 into air intake orifice 59, thus preventing exterior air from entering chamber 48.

In an exemplary embodiment, chamber 48 is about 60 mm in length, about 40 mm in width, and about 100 mm in height. In another embodiment, chamber 48 is about 45 to about 75 mm in length, about 30 mm to about 55 mm in width and about 85 to about 110 mm in height. In an embodiment, main pipe 14 is about 84 mm in length and about 20 mm in diameter. In yet another embodiment, main pipe 14 is about 65 to about 95 mm in length and about 10 mm to about 35 mm in diameter. In another embodiment, main pipe 14 narrows to a diameter of about 10 mm from where spherical valve 31 is housed outwards toward male threaded outlet 16. Spherical valve 31 has a radius of 9 mm. In a further embodiment, main pipe 14 narrows to a diameter of about 5 to 15 mm from where spherical valve 31 is housed outwards toward male threaded outlet 16. In an embodiment, spherical valve 31 has a radius of about 5 to about 15 mm.

Hollow float 41 is about 40 mm in length, about 30 mm in width, and about 80 mm in height, enabling it to tilt from about 1° to about 30° within chamber 48. In one embodiment, bimetallic coil 37 is about 5 mm in height with about a 9 mm radius. In another embodiment, bimetallic coil 37 is about 3 to about 8 mm in height with radius of about 4 mm to about a 13 mm. In an embodiment, bimetallic coil 37 is bent into a spiral shape covering about 20 turns, with an inner diameter of about 4 mm and an outer diameter of about 20 mm. In one embodiment, cylinder 64 is about 5 mm in height with about a 1 mm radius. In another embodiment, cylinder 64 is about 2.5 mm to about 7.5 mm in height with a radius of about 0.5 mm to about 3 mm. Discharge tube 20 is 1 mm in diameter and 50 mm in length with a set water level of 50 mm. Disk 12 is 50 mm in diameter. In another embodiment, discharge tube 20 is about 0.5 mm to about 3 mm in diameter and about 30 mm to about 65 mm in length with a set water level of about 30 mm to about 75 mm. In one embodiment, disk 12 is about 35 to about 65 mm in diameter. In an embodiment, female threaded connector 11 is standard 0.5″ female MNPT and male threaded outlet 16 is standard 0.75 to 11.5 National Hose (NH).

In one embodiment, material of construction for wall-faucet device 100 comprises polyvinyl chloride (PVC). In an alternate embodiment, material of construction for wall-faucet device 100 comprises galvanized steel.

A person of ordinary skill in the art will readily be able to build device 100 using standard procedures; such as casting, hot forging, injection molding, and computer numerical control (CNC) machining.

In an exemplary embodiment, wall-faucet device 100 is removably affixed to an exterior spigot where ball valve system 30 is either in the closed position or open position. When ball valve system 30 is in the closed position, water flows through female threaded connector 11 into main pipe 14, where ball valve system 30 prevents the water from flowing to male threaded outlet 16. When ball valve system 30 is in the open position, water flows through female threaded connector 11 into main pipe 14, where ball valve system 30 allows the water to flow through male threaded outlet 16. In addition, lever 34 can be rotated up to 90 degrees from its open position to its closed position to regulate water flow.

In an alternative embodiment, female threaded connector 11 is ¾″ in diameter using the American National Standard Taper Pipe Thread (NPT) standard with a hexagonal shape attached to disk 12. Disk 12 is removably fixed to exterior wall 67 using a plurality of screws 68 inserted through plurality of holes 13.

In an alternative embodiment, female threaded connector 11 is replaced with an elbow pipe at a 90° or 135° angle, with a free rotation attached female garden hose threaded nut and a flat O-ring allowing device 100 to be directly bolted to an existing exterior faucet (not shown in figures).

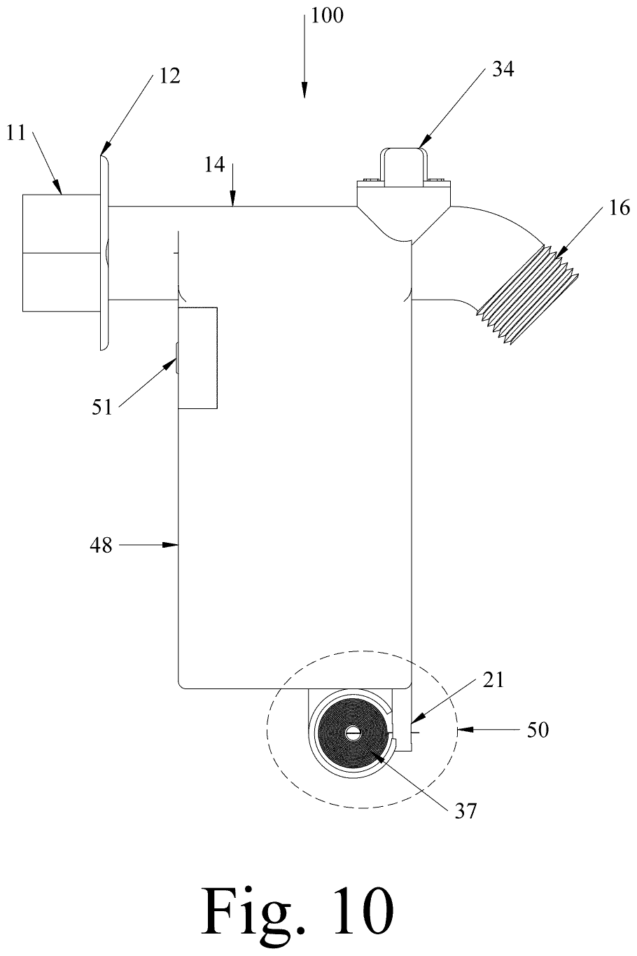

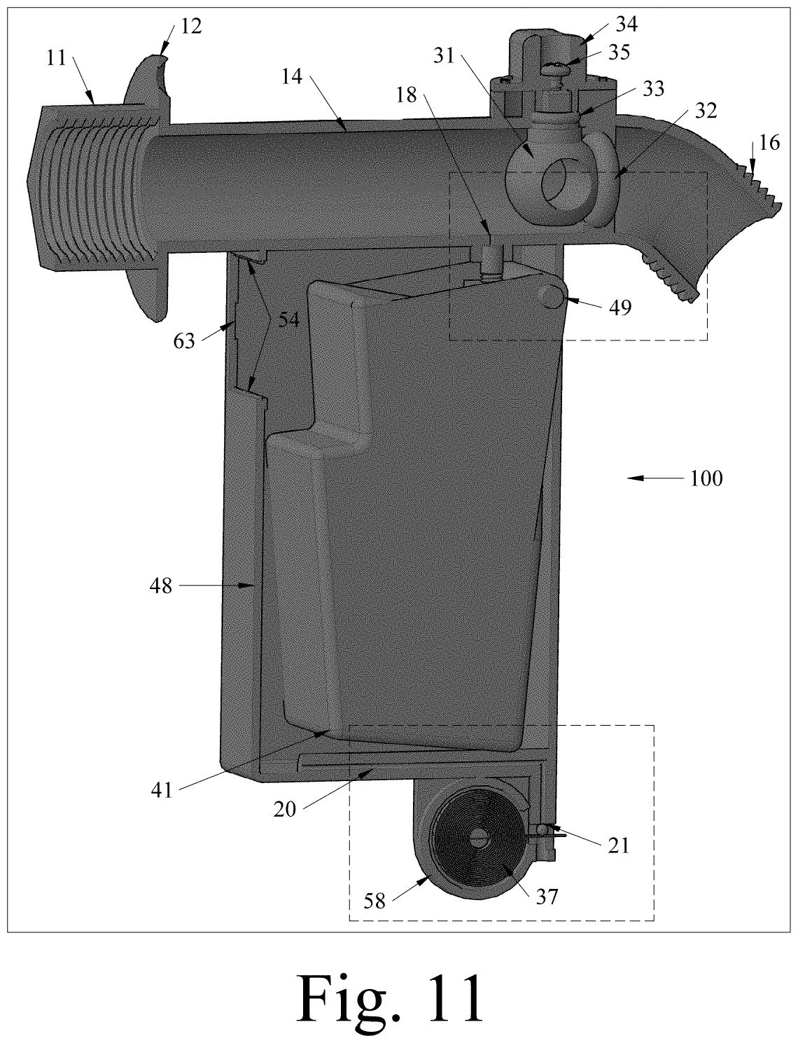

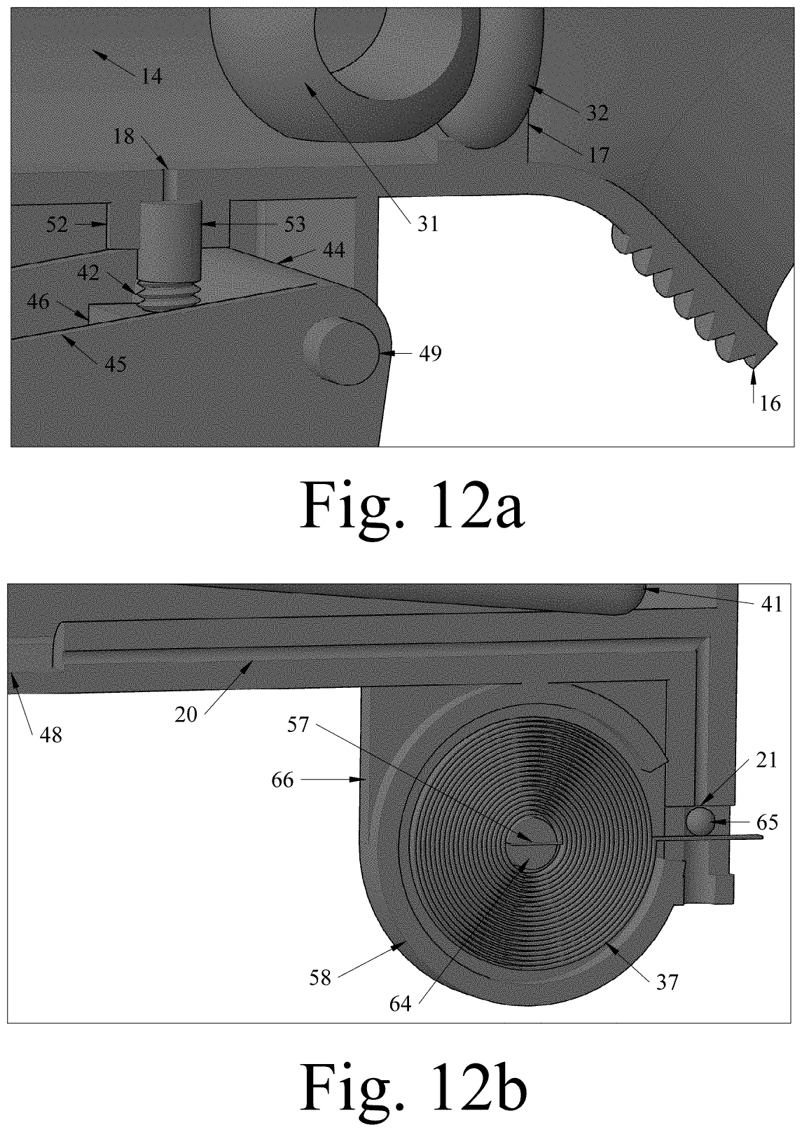

In yet another embodiment, air intake orifice 59 is permanently open by detaching temperature sensitive valve system 50 (see FIGS. 10-12b). Bimetallic coil 37 is clamped to cylinder 64 by inserting end of bimetallic coil 37 into transverse groove 57. Bimetallic coil 37 is wrapped around cylinder 64 and inserted into casing 58. In this embodiment, casing 58 is attached to interior bottom surface 81 and vertical plate 66, wherein second cylindrical piston 36 is replaced by ball 65, which communicates directly with water release orifice 21. Bimetallic coil 37 unwinds as the temperature decreases, separating ball 65 from water release orifice 21; thus, allowing water to flow out of chamber 48 through water release orifice 21. In the alternative, bimetallic coil 37 winds as the temperature increases, compressing ball 65 into water release orifice 21, thus, preventing water from flowing out of chamber 48.

In yet another embodiment, bimetallic coil 37 is mounted in parallel with a worm wheel and meshed to a worm screw allowing the user to calibrate the operating temperature (T) manually (not shown in figures).

In an alternative embodiment, a one-way valve is attached to male threaded outlet 16 preventing water stored in a hose or other attachment to device 100 from contaminating potable water in the water pipe-line system (not shown in figures).

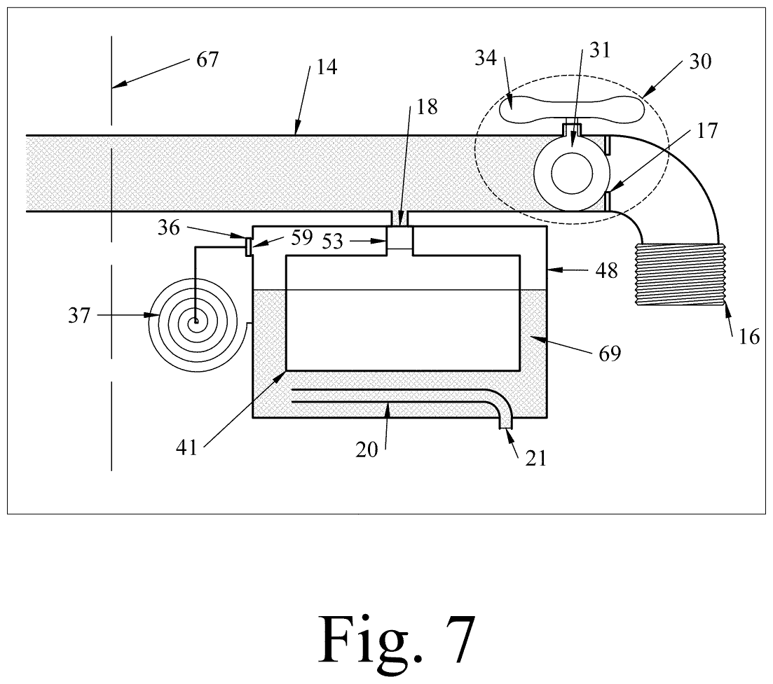

FIGS. 7, 8, and 9 represent the operation of wall-faucet device 100 wherein wall-faucet device 100 is not drawn to scale. In the operation of an exemplary embodiment, wall-faucet device 100 operates at a high temperature when the value of the temperature (T) is above 36° F. (see FIG. 7). In this embodiment the design parameters are as follows: water pressure in main pipe 14 is 40 PSI; water level in chamber 48 is 80 mm; water pressure in chamber 48 is 0 PSI at the surface and approximately 0.116 PSI at water release orifice 21; and air pressure is atmospheric or 0 PSI.

Water 69 enters wall-faucet device 100 through main pipe 14. Spherical valve 31 controls the water flow to male threaded outlet 16. Chamber 48 communicates with the exterior by air intake orifice 59 and water release orifice 21. When water 69 reaches the threshold level of 80 mm within chamber 48, hollow float 41 closes water intake orifice 18 by sealing first cylindrical piston 53 against water intake orifice 18.

The difference in pressure between water 69 at interior bottom surface 81 near discharge tube 20 and the atmospheric pressure exerted on the outside of device 100 allows water 69 to travel through main pipe 14 and exit through male threaded outlet 16. Water 69 flows at a flow rate between 2.10⁻⁷ to 2.10⁻⁵ liters per second by design. Bimetallic coil 37 winds around cylinder 64, holding second cylindrical piston 36 against air intake orifice 59, preventing exterior air from being introduced into chamber 48. As water 69 exits device 100 through water release orifice 21, air pressure in chamber 48 decreases. Water 69 stops flowing once the water pressure at interior bottom surface 81 of chamber 48 is below the exterior atmospheric pressure (plus surface tension).

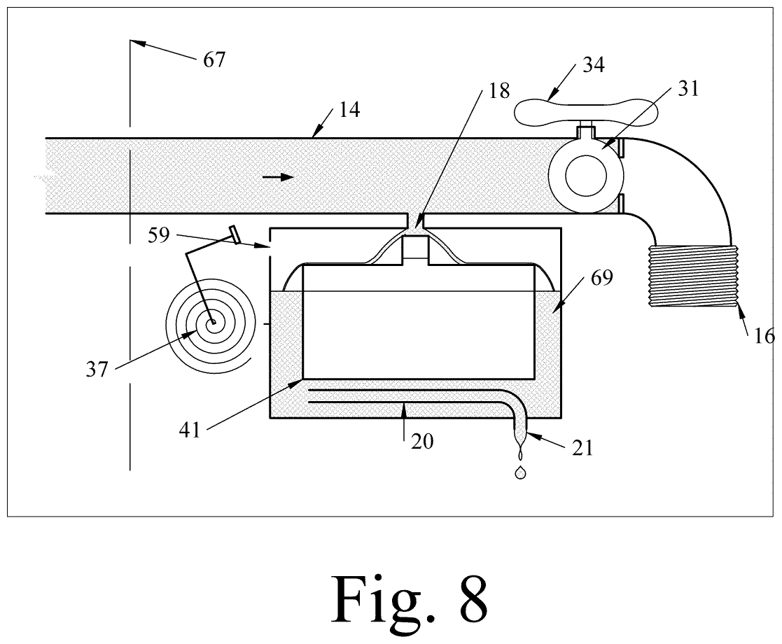

In the operation of an alternate embodiment, wall-faucet device 100 operates at a low temperature when the value of “T” is below 36° F. (see FIG. 8). Water 69 enters wall-faucet device 100 through main pipe 14, and chamber 48 through water intake orifice 18 Bimetallic coil 37 unwinds from cylinder 64, releasing second cylindrical piston 36 and opening air intake orifice 59, thus allowing exterior air into chamber 48. Once the air enters through air intake orifice 59, the air pressure inside chamber 48 reaches the atmospheric value, and water 69 is released out uninterruptedly through discharge tube 20 and water release orifice 21 due to gravity.

Water 69 is exerted through discharge tube 20 and water release orifice 21 at a slow rate. As water 69 is discharged from chamber 48, the water level in chamber 48 decreases lowering hollow float 41 towards interior bottom surface 81. As hollow float 41 descends within chamber 48, water intake orifice 18 opens, allowing water 69 from the main water pipeline system to enter chamber 48 through water intake orifice 18.

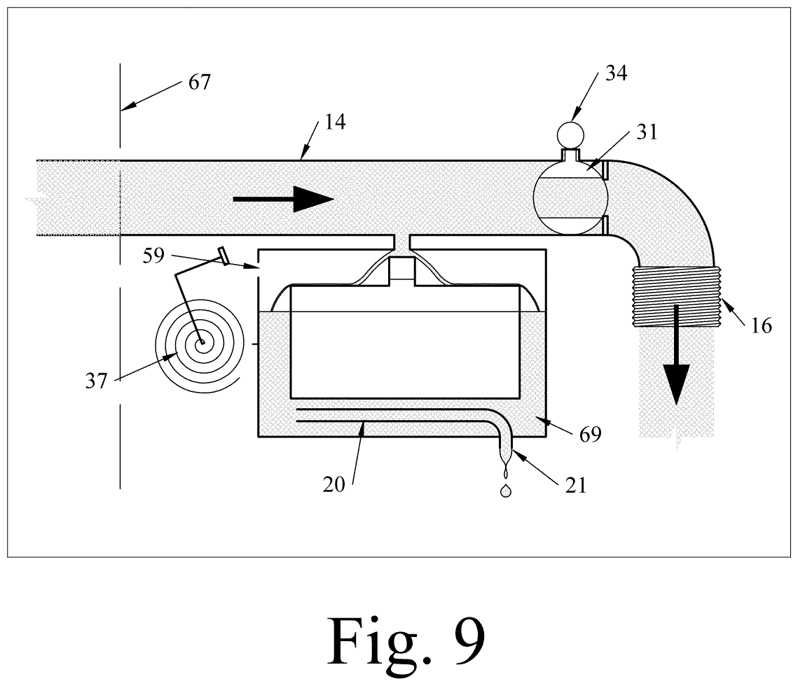

In the operation of an alternate embodiment, lever 34 on wall-faucet device 100 is turned 90°, allowing the spigot to release water (see FIG. 9). As lever 34 is turned, ball valve system 30 rotates, allowing water 69 from main pipe 14 to exit through male threaded outlet 16. Ball valve system 30 is operated independently of the other components of wall-faucet device 100. In addition, ball valve system 30 does not rely on temperature changes to operate.

Thus, specific embodiments of a wall-faucet device for freeze prevention in water pipe-line systems and methods to employ such device have been disclosed. It should be apparent, however, to those skilled in the art that additional modifications besides those already described are possible without departing from the inventive concepts herein.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1) A wall-faucet device for freeze prevention in water pipeline systems, comprising:
(i) a main pipe;
(ii) a chamber; wherein said chamber comprises a water intake orifice, a float valve system, an air intake orifice, a temperature sensitive valve system and a water release orifice.

2) A method for preventing freezing in water pipeline systems according to claim 1, comprising:
(a) operating at a temperature between −70° F. and 140° F.;
(b) operating at a water pressure between 5 PSI and 70 PSI;
(c) water entering said device through said main pipe;
(d) controlling the water flow from said main pipe to said chamber through said water intake orifice by said float valve system;
(e) closing said water intake orifice by said float valve system when water reaches the threshold level within said chamber;
(f) communicating with said exterior by air intake orifice(s) and said water release orifice in said chamber;
(g) controlling the water flow from said chamber to exterior through said water release orifice by said temperature sensitive system, either
(h) closing said water release orifice by said temperature sensitive system when temperature is above 36° F., and opening said water release orifice by said temperature sensitive system when temperature is below 36° F., while maintaining said air intake orifice(s) open at all times; or
(i) closing said air intake orifice(s) by said temperature sensitive system when temperature is above 36° F. and opening said air intake orifice(s) by said temperature sensitive system when temperature is below 36° F., while maintaining said water release orifice open at all times.

3) A wall-faucet device for freeze prevention in water pipe-line systems comprising:
(i) a chamber comprising a discharge tube, a water release orifice, an interior top surface, an interior back surface, an interior bottom surface, an interior front surface, an interior first side surface, and an interior second side surface,
(ii) a main pipe comprising a water intake orifice between said main pipe and said chamber;
(iii) a ball valve system comprising a valve O-ring, a spherical valve, a lever, a faucet O-ring, and a port; wherein said valve O-ring is mounted on said spherical valve, wherein said lever is attached through said valve O-ring to said spherical valve by a fastener, and wherein said faucet O-ring is located at the joint of said spherical valve and said port;
(iv) a float valve system located in said chamber, wherein said float valve system comprises a hollow float, a cylindrical threaded rod, a horizontal cylindrical shell, a plurality of triangular plates, a rectangular tab, a hexagonal cavity, a horizontal cylinder, a first cylindrical piston, a plurality of protrusions; wherein said plurality of triangular plates are permanently affixed between said hollow float and said horizontal cylindrical shell; wherein said horizontal cylinder is inserted through said horizontal cylindrical shell fixedly attaching said horizontal cylindrical shell between said interior first side surface and said interior second side surface of said chamber; wherein said rectangular tab is permanently attached to said horizontal cylindrical shell or top surface of said hollow float; wherein said cylindrical threaded rod screws into said rectangular tab by said hexagonal cavity; wherein said first cylindrical piston is positioned between said cylindrical threaded rod and said plurality of protrusions; wherein said plurality of protrusions are configured to hold said first cylindrical piston in place; wherein said plurality of protrusions are located in said interior top surface of said chamber; and
(v) a temperature sensitive valve system, wherein said temperature sensitive valve system comprises a second cylindrical piston, a bimetallic coil, a lid, a plurality of horizontal rails, a cantilever section, a transverse groove, a casing, an air intake orifice, a housing box, a tab, an indentation, and a cylinder; wherein said temperature sensitive valve system is confined to said housing box wherein said lid comprises a plurality of apertures between said temperature sensitive valve system and the exterior of said device, wherein said lid is removably attached to said housing box; wherein said indentation is configured to hold said tab securely in place; wherein said bimetallic coil is clamped to said cylinder by said transverse groove; and wherein said bimetallic coil is wrapped around said cylinder and is housed in said casing.

4) The freeze prevention device according to claim 3, wherein said freeze prevention device comprises polyvinyl chloride (PVC).

5) The freeze prevention device according to claim 3, wherein said freeze prevention device comprises galvanized steel.

6) The freeze prevention device according to claim 3, wherein said freeze prevention device further comprises a one-way valve attached to said male threaded outlet.

7) A wall-faucet device for freeze prevention in water pipe-line systems comprising:
(i) a chamber; wherein said chamber comprises a water intake orifice, a discharge tube, a water release orifice, an interior top surface, an interior back surface, an interior bottom surface, an interior front surface, an interior first side surface, and an interior second side surface;
(ii) a main pipe comprising a water intake orifice between said main pipe and said chamber; wherein said main pipe comprises a female threaded connector on one end and a male threaded connector on the opposite end; wherein a disk is attached between said main pipe and said female threaded connector using a plurality of screws through a plurality of holes on said disk.
(iii) a ball valve system comprising a valve O-ring, a spherical valve, a lever, a faucet O-ring, and a port; wherein said valve O-ring is mounted on said spherical valve, wherein said lever is attached through valve O-ring to said spherical valve by a fastener, and wherein said faucet O-ring is located at the joint of said spherical valve and said port;
(iv) a float valve system located in said chamber, wherein said float valve system comprises a hollow float, a cylindrical threaded rod, a horizontal cylindrical shell, a plurality of triangular plates, a rectangular tab, a hexagonal cavity, a horizontal cylinder, a first cylindrical piston, a plurality of protrusions; wherein said plurality of triangular plates are permanently affixed between said hollow float and said horizontal cylindrical shell; wherein said horizontal cylinder is inserted through said horizontal cylindrical shell fixedly attaching said horizontal cylindrical shell between said interior first side surface and said interior second side surface of said chamber; wherein said rectangular tab is permanently attached to said horizontal cylindrical shell or said hollow float top surface; wherein said cylindrical threaded rod screws into said rectangular tab by said hexagonal cavity; wherein said first cylindrical piston is positioned between said cylindrical threaded rod and said plurality of protrusions; wherein said plurality of protrusions are configured to hold said first cylindrical piston in place; wherein said plurality of protrusions are affixed to said interior top surface of said chamber; and
(v) a temperature sensitive valve system, wherein said temperature sensitive valve system comprises a second cylindrical piston, a bimetallic coil, a lid, a plurality of horizontal rails, a cantilever section, a transverse groove, a casing, an air intake orifice, a housing box, a tab, an indentation, and a cylinder; wherein said temperature sensitive valve system is confined to said housing box; wherein said lid comprises a plurality of apertures between said temperature sensitive valve system and the exterior of said device for aerial communication; wherein said lid is removably attached to said housing box by sliding said lid along said plurality of horizontal rails; wherein said indentation is configured to hold said tab securely in place; wherein said bimetallic coil is clamped to said cylinder by said transverse groove; wherein said bimetallic coil is wrapped around said cylinder and housed in said casing; wherein said second cylindrical piston separates from said air intake orifice as the temperature decreases or compresses said second cylindrical piston from said air intake orifice as the temperature increases.

8) The freeze prevention device according to claim 7, wherein said freeze prevention device comprises polyvinyl chloride (PVC).

9) The freeze prevention device according to claim 7, wherein said freeze prevention device comprises galvanized steel.

10) The freeze prevention device according to claim 7, wherein said freeze prevention device further comprises a one-way valve attached to said male threaded outlet.
